(19) United States
(12) Patent Application Publication
(10) Pub. No.: US 2016/0030859 A1
(43) Pub. Date: Feb. 4, 2016

(54) APPARATUS FOR MANUFACTURING SALT

(71) Applicant: Jin Ho KIM, Gangnam-gu, Seoul (KR)

(72) Inventor: Jin Ho KIM, Seoul (KR)

(21) Appl. No.: 14/775,022

(22) PCT Filed: Jul. 26, 2013
(86) PCT No.: PCT/KR2013/006748

§ 371 Date: Sep. 11, 2015

(30) Foreign Application Priority Data
Mar. 20, 2013 (KR) 10-2013-0029624

(51) Int. Cl. B01D 9/00; B01D 1/18; A23L 1/237; C01D 3/06

(52) U.S. Cl. CPC B01D 9/0027; C01D 3/06; B01D 9/0081; B01D 9/0031; B01D 9/005; B01D 1/18; A23L 1/237; B01D 2009/0086; A23V 2002/00

(57) ABSTRACT

The present invention relates to an apparatus for manufacturing salt, and more particularly to an apparatus for manufacturing salt, which is capable of obtaining mineral salt containing a high concentration of minerals, manufacturing salt at relatively low cost in a relatively small space, and exhibiting maximum efficiency of drying or evaporation since seawater is heated and sprayed onto a cloth or net.

### TECHNICAL FIELD

The present invention relates to an apparatus for manufacturing salt, and more particularly to an apparatus for manufacturing salt, which is capable of obtaining mineral salt containing a high concentration of minerals, manufacturing salt at relatively low cost in a relatively small space, and exhibiting maximum efficiency of drying or evaporation since seawater is heated and sprayed onto a cloth or net.

### BACKGROUND ART

In general, the most popular method for manufacturing salt is a method in which salt is extracted by putting seawater in a salt pan and then drying the seawater.

Salt manufactured by the above method contains approximately 60 different kinds of minerals such as calcium and magnesium, and the minerals are widely used as nutrients that are beneficial to humans.

However, the method has problems in that it is difficult to secure salt pans due to the development of shorelines, and in that it takes a lot of manpower to produce salt in a salt pan. Due to these problems, the production of natural salt is currently decreasing every year, and thus an apparatus and method for artificially manufacturing salt, which has about the same components as natural salt, is being developed in order to substitute for natural salt. As a representative example, there is “Japanese Patent Publication No. S63-27290” which discloses a method of bringing seawater into a factory and manufacturing salt in an electrical manner using an ion exchange resin film.

However, the salt manufactured by the above method has very low content of nutrients that are beneficial to humans, as well as very low content of minerals such as calcium and magnesium which are necessary to humans, compared to natural salt. For this reason, the above salt is not as suitable for use as food, compared to natural salt.

Meanwhile, Korean Patent No. 10-1080994 discloses an apparatus for manufacturing salt. The apparatus includes a drying section, which includes a first drying portion having a first drying space therein and a second drying portion installed in the first drying space and having a second drying space connected to the first drying space therein, a raw material supply section which is connected to one side of the drying section for spraying of a salt concentrate in a fine particle form, and a heating section which is connected to one side of the drying section to heat the drying spaces.

However, the above patent pertains to a manner in which seawater is mixed with air within an injection nozzle and salt is crushed into fine particles. For this reason, when the nozzle is used for a long time, it is blocked due to a bent portion of a venture pipe, and thus it is difficult to continuously operate the apparatus. In addition, the apparatus is problematic in that the efficiency with which seawater or salt is atomized is low.

Meanwhile, modern people suffer from nutrient deficiencies due to a lack of minerals. The lack of calcium and magnesium causes chronic diseases including diabetes and cardiovascular and circulatory disorders. The treatment of diseases merely by supplementing calcium and magnesium has been proven, as reported in a number of papers.

However, an apparatus for manufacturing mineral salt having a high content of minerals using seawater has been not developed until now.

In addition, conventional apparatuses for manufacturing salt are inefficient because they have a complicated structure or take up a large amount of space, and it is very time consuming to manufacture salt.

### DISCLOSURE

### Technical Problem

Therefore, the present invention has been made in view of the above problems, and it is an object of the present invention to provide an apparatus for manufacturing salt, capable of obtaining mineral salt containing a high concentration of minerals, and manufacturing salt at relatively low cost in a relatively small space.

In addition, it is another object of the present invention to provide an apparatus for manufacturing salt, capable of exhibiting maximum efficiency of drying or evaporation since seawater is heated and sprayed onto a cloth or net.

In addition, it is still another object of the present invention to provide an apparatus for manufacturing salt, capable of accelerating evaporation of seawater by supplying heated air into a salt manufacturing chamber, and atomizing and spraying seawater from a nozzle.

In addition, it is a further object of the present invention to provide an apparatus for manufacturing salt, capable of further including a seawater concentration unit and supplying previously concentrated seawater into a salt manufacturing chamber, so as to continuously and efficiently manufacture salt.

### Technical Solution

In accordance with an aspect of the present invention, the above and other objects can be accomplished by the provision of an apparatus for manufacturing salt that crystallizes salt in a manner of spraying seawater onto a cloth or net. The apparatus includes a salt manufacturing chamber having an internal space, a cloth or net vertically installed in the salt manufacturing chamber, a seawater jet device installed at an upper portion of the salt manufacturing chamber to atomize and spray seawater onto the cloth or net, a seawater supply pipe for supplying the seawater to the seawater jet device, and a heating means for heating the seawater or the salt manufacturing chamber, wherein the salt is crystallized while the seawater sprayed from the seawater jet device flows down along the cloth or net.

The seawater jet device may be a nozzle, having a horn or truncated pyramid shape, into which seawater and air are introduced. The seawater supplied through the seawater supply pipe may be primarily atomized by intersecting with the air in the nozzle, and the seawater, which is primarily atomized and discharged, may be secondarily atomized in a vertex region of the nozzle.

The seawater jet device may spray seawater in an atomized form using an ultrasonic vibrator.

The seawater supply pipe may be arranged at a lower portion of the salt manufacturing chamber to be connected to the seawater jet device, and the heating means may be a boiler installed at a bottom of the salt manufacturing chamber to heat the seawater in the seawater supply pipe.

The heating means may be a hot air device installed at a lower portion of the salt manufacturing chamber to supply heated air into the salt manufacturing chamber.

The apparatus may further include a seawater concentration unit. The seawater concentration unit may include a concentration chamber having an internal space, a cloth or net vertically installed in the concentration chamber, a seawater jet device installed at an upper portion of the concentration chamber to atomize and spray seawater onto the cloth or net, a seawater supply pipe for supplying the seawater to the seawater jet device, and a heating means for heating the seawater or the concentration chamber, and may concentrate the seawater. The concentrated seawater may be supplied to the seawater jet device of the salt manufacturing chamber through the seawater supply pipe of the salt manufacturing chamber.

The salt manufacturing chamber may be formed with a steam outlet port for discharging steam therein.

### Advantageous Effects

The apparatus for manufacturing salt having the above-mentioned configurations according to the present invention can be used to obtain mineral salt containing a higher concentration of minerals compared to that obtained from typical seawater or deep ocean water, and to manufacture salt at relatively low cost in a relatively small space.

In addition, the apparatus for manufacturing salt according to the present invention can exhibit maximum efficiency of drying or evaporation since seawater is heated and sprayed onto a cloth or net.

Moreover, the apparatus for manufacturing salt according to the present invention can accelerate the evaporation of seawater by supplying heated air into a salt manufacturing chamber, and atomizing and spraying seawater from a nozzle.

Furthermore, the apparatus for manufacturing salt according to the present invention can further include a seawater concentration unit and supply previously concentrated seawater into the salt manufacturing chamber, so as to continuously and efficiently manufacture salt.

### DESCRIPTION OF DRAWINGS

The above and other objects, features and other advantages of the present invention will be more clearly understood from the following detailed description taken in conjunction with the accompanying drawings, in which:

FIG. 1 is a conceptual view illustrating an apparatus for manufacturing salt according to an embodiment of the present invention;

FIG. 2 is a top view illustrating a seawater supply pipe installed at the lower portion of a salt manufacturing chamber according to the embodiment of the present invention;

FIG. 3 is a cross-sectional view illustrating one nozzle according to the embodiment of the present invention;

FIG. 4 is a cross-sectional view illustrating a state in which seawater and air are discharged through the nozzle according to the embodiment of the present invention; and

FIG. 5 is a conceptual view illustrating an apparatus for manufacturing salt according to another embodiment of the present invention.

### BEST MODE

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Thus, the drawings are not necessarily to scale and in some instances, proportions may have been exaggerated in order to clearly illustrate features of the embodiments. Throughout the disclosure, like reference numerals refer to like parts throughout the various figures and embodiments of the present invention.

In addition, the detailed descriptions of functions and constructions well known in the art may be omitted to avoid unnecessarily obscuring the gist of the present invention.

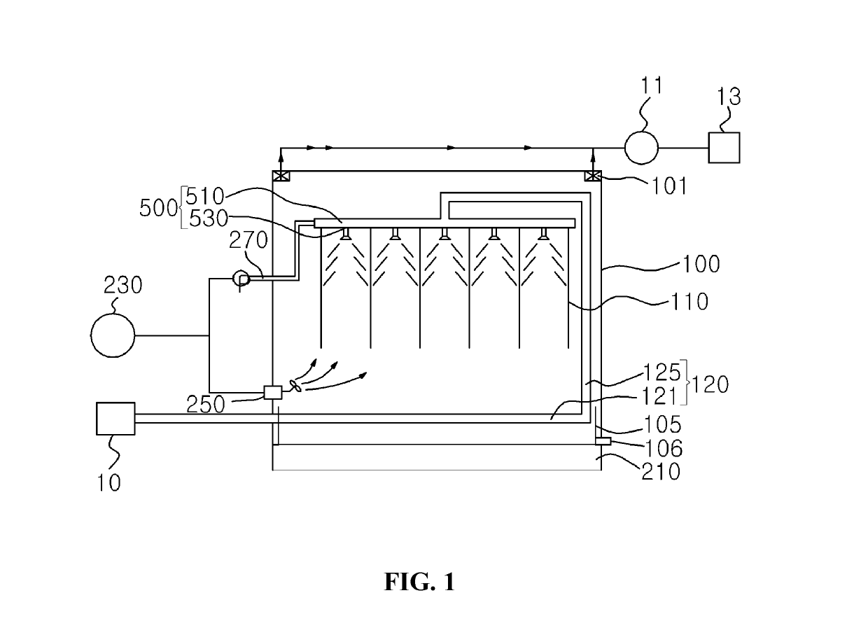

FIG. 1 is a conceptual view illustrating an apparatus for manufacturing salt according to an embodiment of the present invention.

Referring to FIG. 1, the apparatus for manufacturing salt according to the embodiment of the present invention may generally include a salt manufacturing chamber 100, cloths or nets 110, a seawater jet device 500, a seawater supply pipe 120, and a heating means.

Specifically, the apparatus for manufacturing salt according to the embodiment of the present invention crystallizes and manufactures salt in a manner whereby seawater is sprayed onto the cloths or nets 110. The apparatus may include the salt manufacturing chamber 100 having an internal space, the cloths or nets 110 which are vertically installed in the salt manufacturing chamber 100, the seawater jet device 500 which is installed at the upper portion of the salt manufacturing chamber 100 to atomize and spray seawater onto the cloths or nets 110, the seawater supply pipe 120 for supplying the seawater to the seawater jet device 500, and the heating means for heating the seawater or the salt manufacturing chamber.

The salt manufacturing chamber 100 serves to provide a space in which salt may be manufactured using seawater introduced from the outside. The cloths or nets 110, the seawater jet device 500, the seawater supply pipe 120, the heating means, and the like are installed in the salt manufacturing chamber 100. The bottom of the salt manufacturing chamber 100, specifically the upper portion of a boiler 210 may be provided with a tray 105 for accommodating salt or concentrated seawater. An outlet port 106 may be formed through one side of the tray and one side of the salt manufacturing chamber.

The cloths or nets 110 serve to widely distribute the atomized and sprayed seawater and increase drying or concentration efficiency. The cloths or nets 110 are preferably installed to extend vertically such that the seawater, which is directly sprayed onto the cloths or nets 110, may be dried or evaporated while flowing down along the cloths or nets 110. Salt crystallized on the cloths or nets may be collected by shaking the cloths or nets.

The seawater jet device 500 serves to atomize and spray seawater onto the cloths or nets, and may include a pipe 510, and nozzles 530 connected to the pipe 510. Here, the nozzles 530 may be installed so as to correspond to the number of cloths or nets 110.

Specifically, each nozzle 530 of the seawater jet device 500 may be exemplified as being installed between the associated adjacent cloths or nets which are installed at a predetermined interval. The appropriate number of nozzles may be installed in consideration of the distance and width between the cloths or nets, etc.

The seawater jet device 500 accelerates the drying or evaporation of seawater by atomizing and spraying the seawater. The seawater jet device 500 may also spray seawater in a mist form as in a spray manner, spray seawater and air which are mixed with each other, or spray seawater in an atomized form using an ultrasonic vibrator.

The seawater supply pipe 120 serves to supply seawater, which is stored in a seawater reservoir 10, to the seawater jet device 500. One side of the seawater supply pipe 120 is connected to the seawater reservoir 10, and the other side thereof is connected to the pipe 510 of the seawater jet device 500.

The heating means serves to accelerate the evaporation of seawater, and may include a boiler 210, an air heating device 230, a hot air device 250, and a heated air supply pipe 270.

The boiler 210 heats seawater in the seawater supply pipe so that the heated seawater evaporates more quickly when it is sprayed from the nozzles 530.

Seawater is heated by the boiler 210 to a temperature which is equal to or greater than at least 40° C., and preferably to a temperature of 80 to 90° C. Heating the seawater to a temperature of 80 to 90° C. may increase drying efficiency while retaining as much of minerals and nutrients contained in the seawater as possible.

The boiler 210 is preferably installed at the lower portion of the salt manufacturing chamber 100. Through such installation, the boiler 210 heats the seawater supply pipe 120 and simultaneously heats the interior of the salt manufacturing chamber 100, thereby increasing thermal efficiency.

Meanwhile, the seawater supply pipe 120 may consist of a heating part 121 which is a region heated on the boiler 210, and a connection part 125 which is connected to the pipe 510 located at the upper portion of the salt manufacturing chamber 100.

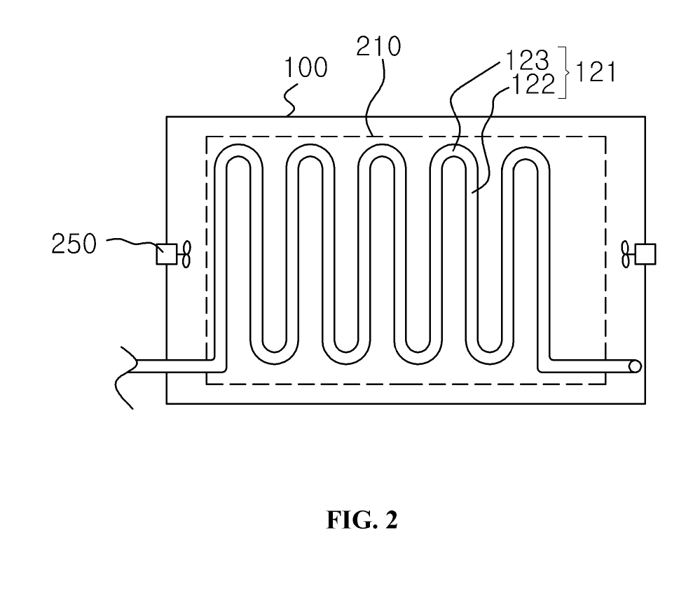

FIG. 2 is a top view illustrating the seawater supply pipe installed at the lower portion of the salt manufacturing chamber according to the embodiment of the present invention. Referring to FIG. 2, the heating part 121 may be exemplified as having a sinuate structure in which linear portions 122, which are linearly arranged, and bent portions 123, which are bent from the respective linear portions 122, are repeatedly formed.

The air heating device 230 serves to heat air and supply the heated air to the hot air device 250 and the heated air supply pipe 270.

The hot air device 250 serves to supply heated air into the salt manufacturing chamber 100 so as to accelerate the evaporation of seawater sprayed onto the cloths or nets 110.

The hot air device 250 is installed at the lower portion of the salt manufacturing chamber 100, and is preferably oriented upward such that the heated air is blown upward.

Meanwhile, the heated air supply pipe 270 is equipped with a pump P, and serves to supply heated air to the pipe 510. Since heated air and seawater are sprayed from the nozzles 530 in the state in which they are mixed, evaporation efficiency can be further increased.

The seawater evaporated by the boiler 210 and the hot air device 250 is discharged through a steam outlet port 101 which is formed through the upper side of the salt manufacturing chamber 100. The steam outlet 101 may be provided with a ventilator, etc. such that steam is forcibly discharged, and the discharged steam may be stored in a steam collection container 13 via a cooling device 11.

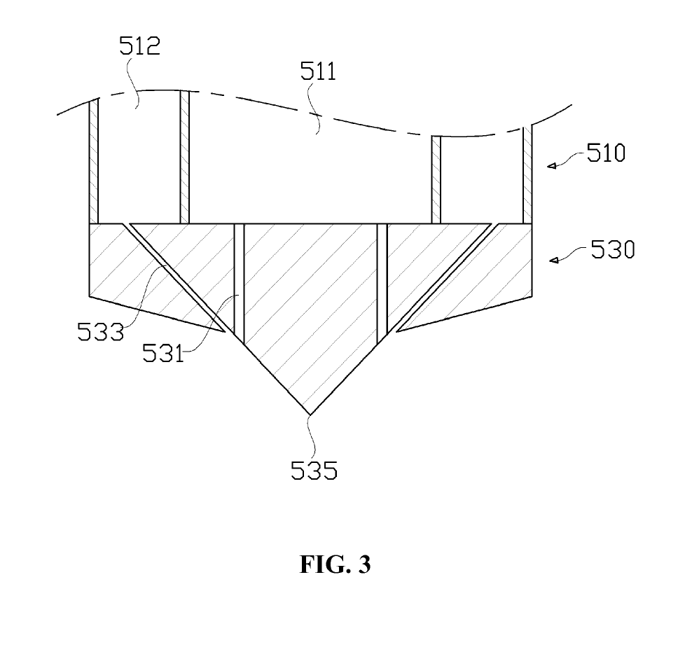

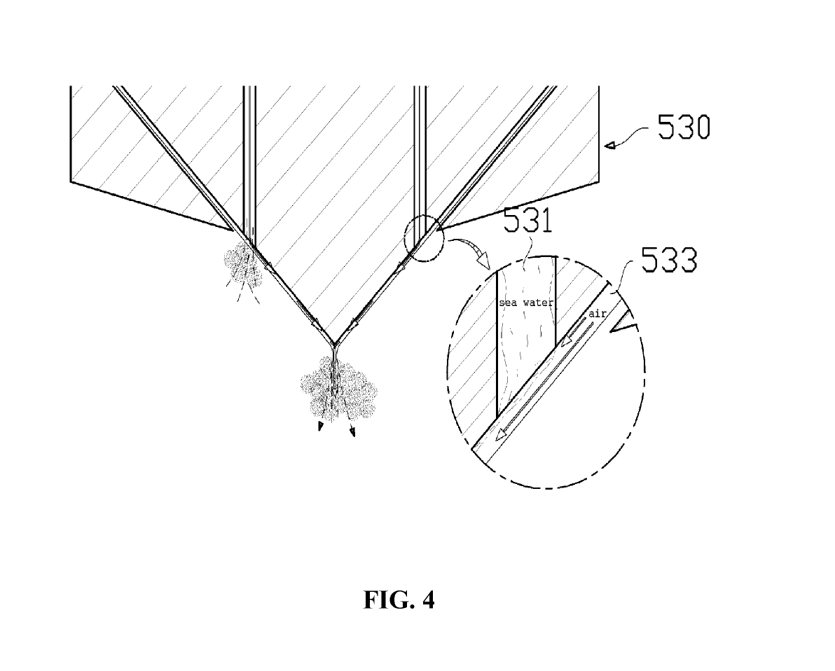

FIG. 3 is a cross-sectional view illustrating one nozzle according to the embodiment of the present invention. FIG. 4 is a cross-sectional view illustrating a state in which seawater and air are discharged through the nozzle according to the embodiment of the present invention.

One end portion of each nozzle 530 according to the embodiment of the present invention is connected to the pipe, and the other end portion thereof is formed with a collision part 535 which collides with seawater. The nozzle 530 is formed with a seawater discharge part 531 and an air discharge part 533 which are respectively connected to first and second passages 511 and 512.

The seawater is introduced into the first passage, and the heated air in the heated air supply pipe is introduced into the second passage. Although not illustrated, the pipe is divided into a seawater supply pipe and an air supply pipe, and the seawater supply pipe and the air supply pipe are respectively connected to the first and second passages.

The seawater discharged through the seawater discharge part 531 is primarily atomized by the air discharged from the air discharge part 533. The pressure of the air discharged through the air discharge part 533 is greater than the injection pressure of the seawater discharged through the seawater discharge part 531, whereby the seawater is smoothly atomized.

It is preferable that the collision part 535 be formed at a vertex region of the nozzle having a horn shape (e.g. a conic shape), and that the air discharge part 533 be formed at the same angle as the side surface of the collision part 535. The seawater discharge part 531 is vertically formed, and the seawater, which is primarily atomized, is secondarily atomized in the region of the collision part 535.

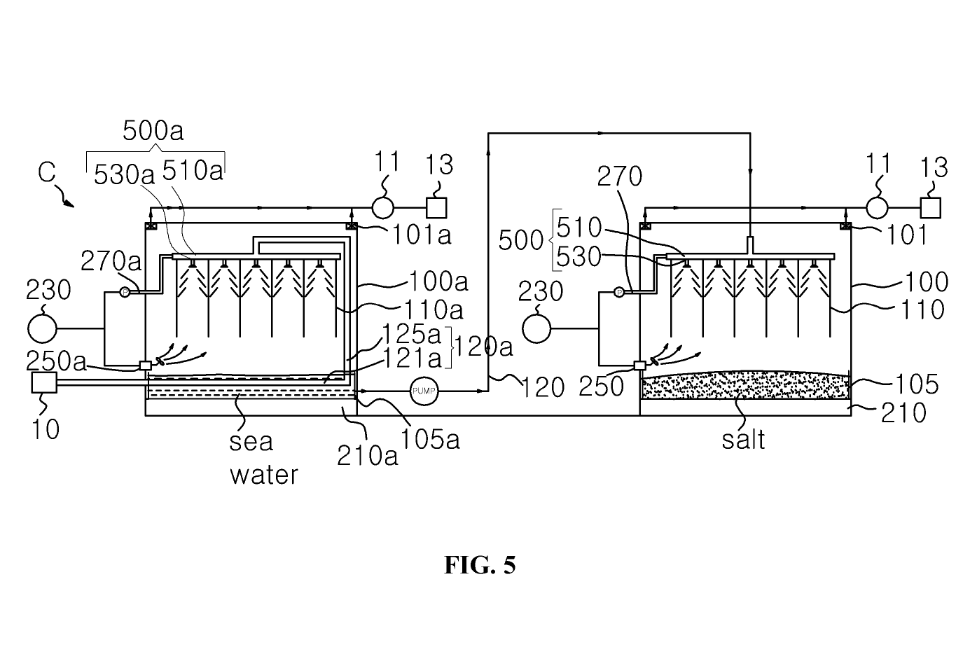

FIG. 5 is a conceptual view illustrating an apparatus for manufacturing salt according to another embodiment of the present invention.

Referring to FIG. 5, the apparatus for manufacturing salt according to the embodiment of the present invention may further include a seawater concentration unit C, in addition to the above configurations described in the previous embodiment.

The seawater concentration unit C serves to concentrate and supply seawater to the salt manufacturing chamber 100. The seawater concentration unit C may include a concentration chamber 100a having an internal space, cloths or nets 110a which are vertically installed in the concentration chamber 100a, a seawater jet device 500a which is installed at the upper portion of the concentration chamber 100a to atomize and spray seawater onto the cloths or nets 110a, a seawater supply pipe 120a for supplying the seawater to the seawater jet device 500a, and a heating means for heating the seawater or the concentration chamber 100a.

Since the cloths or nets 110a, the seawater jet device 500a, the heating means, etc. are identical or similar to the cloths or nets 110, the seawater jet device 500, the heating means, etc., which are previously described with reference to FIGS. 1 to 4, detailed descriptions thereof will be omitted.

Unlike the above-mentioned salt manufacturing chamber, in which salt is extracted, seawater is first concentrated to have a predetermined salinity in the concentration chamber 100a, and the concentrated seawater is then supplied from the concentration chamber 100a to the salt manufacturing chamber 100.

Accordingly, the seawater in the seawater reservoir 10 is supplied to the concentration chamber 100a via the seawater supply pipe 120a.

The seawater in the seawater supply pipe 120a is supplied to the seawater jet device 500a in the state in which the seawater is heated by the heating means, specifically a boiler 210a. Air heated by a hot air device 250a, as another heating means, is supplied into the concentration chamber 100a.

The seawater supplied to the seawater jet device 500a is atomized and sprayed onto the cloths or nets 110a.

The seawater sprayed onto the cloths or nets 110a is evaporated while flowing down toward a tray 105a located at the bottom of the concentration chamber 100a, and the concentrated seawater is stored in the tray 105a.

The concentrated seawater in the concentration chamber 100a is supplied to the seawater jet device 500 of the salt manufacturing chamber 100 through the seawater supply pipe 120a.

Meanwhile, the seawater in the seawater reservoir 10 has a concentration of about 3.5% (35%). The seawater is concentrated to have a concentration of 20 to 30% while passing through the seawater concentration unit C, and is supplied to the salt manufacturing chamber 100.

The seawater, which is concentrated to have the concentration of 20 to 30% by means of the seawater concentration unit C, is supplied to the salt manufacturing chamber, and then undergoes a drying or evaporation process, thereby enabling salt to be extracted.

The apparatus for manufacturing salt according to the present invention further includes the seawater concentration unit, and thus can have an advantage of continuously performing a salt manufacturing process and shortening a salt manufacturing time.

Various embodiments have been described in the best mode for carrying out the invention. Although embodiments have been described with reference to a number of illustrative embodiments thereof, it should be understood that numerous other modifications and applications may be devised by those skilled in the art that will fall within the intrinsic aspects of the embodiments. More particularly, various variations and modifications are possible in concrete constituent elements of the embodiments. In addition, it is to be understood that differences relevant to the variations and modifications fall within the spirit and scope of the present disclosure defined in the appended claims.

1. An apparatus for manufacturing salt that crystallizes salt in a manner of spraying seawater onto a cloth or net, the apparatus comprising:
a salt manufacturing chamber having an internal space;
a cloth or net vertically installed in the salt manufacturing chamber;
a seawater jet device installed at an upper portion of the salt manufacturing chamber to atomize and spray seawater onto the cloth or net;
a seawater supply pipe for supplying the seawater to the seawater jet device; and
a heating means for heating the seawater or the salt manufacturing chamber,
wherein the salt is crystallized while the seawater sprayed from the seawater jet device flows down along the cloth or net.

2. The apparatus according to claim 1, wherein:
the seawater jet device is a nozzle, having a horn or truncated pyramid shape, into which seawater and air are introduced; and
the seawater supplied through the seawater supply pipe is primarily atomized by intersecting with the air in the nozzle, and the seawater, which is primarily atomized and discharged, is secondarily atomized in a vertex region of the nozzle.

3. The apparatus according to claim 1, wherein the seawater jet device sprays seawater in an atomized form using an ultrasonic vibrator.

4. The apparatus according to claim 1, wherein:
the seawater supply pipe is arranged at a lower portion of the salt manufacturing chamber to be connected to the seawater jet device; and
the heating means is a boiler installed at a bottom of the salt manufacturing chamber to heat the seawater in the seawater supply pipe.

5. The apparatus according to claim 1, wherein the heating means is a hot air device installed at a lower portion of the salt manufacturing chamber to supply heated air into the salt manufacturing chamber.

6. The apparatus according to claim 1, further comprising a seawater concentration unit, wherein:
the seawater concentration unit comprises a concentration chamber having an internal space, a cloth or net vertically installed in the concentration chamber, a seawater jet device installed at an upper portion of the concentration chamber to atomize and spray seawater onto the cloth or net, a seawater supply pipe for supplying the seawater to the seawater jet device, and a heating means for heating the seawater or the concentration chamber, and concentrates the seawater; and
the concentrated seawater is supplied to the seawater jet device of the salt manufacturing chamber through the seawater supply pipe of the salt manufacturing chamber.

7. The apparatus according to claim 1, wherein the salt manufacturing chamber is formed with a steam outlet port for discharging steam therein.
